(19) United States
(12) Patent Application Publication
(10) Pub. No.: US 2026/0039230 A1
(43) Pub. Date: Feb. 5, 2026

(54) APPLIANCE COMPRESSOR DEMAGNETIZATION DETECTION

(71) Applicant: Haier US Appliance Solutions, Inc., Wilmington, DE (US)

(72) Inventors: Joshua Duane Longenecker, Louisville, KY (US); Joseph Wilson Latham, Louisville, KY (US)

(21) Appl. No.: 18/788,965

(22) Filed: Jul. 30, 2024

(51) Int. Cl. H02P 21/14; H02P 21/13; H02P 21/18; H02P 21/22

(52) U.S. Cl. CPC H02P 21/141; H02P 21/13; H02P 21/18; H02P 21/22; H02P 2207/05

(57) ABSTRACT

A method of operating an appliance includes estimating a flux of a compressor of a sealed system of the appliance while operating the compressor. The method also includes comparing the estimated flux of the compressor to a nominal flux of the compressor and/or determining the estimated flux of the compressor is below a predefined threshold. The method further includes setting a fault condition of the compressor in response to comparing the estimated flux of the compressor to the nominal flux of the compressor and/or in response to determining the estimated flux of the compressor is below the predefined threshold.

### FIELD OF THE INVENTION

The present subject matter relates generally to appliances, such as refrigerator appliances, air conditioner appliances, and other similar appliances which include a heating and/or cooling system having a compressor, such as a variable speed compressor. More particularly, the present subject matter relates to systems and methods for detecting demagnetization of the compressor motor in such appliances.

### BACKGROUND OF THE INVENTION

Various appliances includes a sealed system for heating and/or cooling. For example, Heating, Ventilation, and Air Conditioning (HVAC) appliances include a sealed system for treating (e.g., heating or cooling, which may be determined by a reversing valve in the sealed system) air provided to a conditioned space, e.g., a room or rooms. As another example, many refrigerator appliances include a sealed system which provides chilled air to one or more food storage compartments within the refrigerator appliance. As further examples, a heat pump (which is a type of sealed system) may be provided in a water heater appliance for heating water in a tank of the water heater appliance or in a dryer appliance to provide warm and dry air to a drum within the dryer appliance.

Further with respect to the HVAC appliance example noted above, air conditioner units or air conditioning appliance units are conventionally utilized to adjust the temperature within structures such as dwellings and office buildings. In particular, one-unit type room air conditioner units, such as single-package vertical units (SPVU), or package terminal air conditioners (PTAC) may be utilized to adjust the temperature in, for example, a single room or group of rooms of a structure. A typical one-unit type air conditioner or air conditioning appliance includes an indoor portion and an outdoor portion. The indoor portion generally communicates (e.g., exchanges air) with the area within a building, and the outdoor portion generally communicates (e.g., exchanges air) with the area outside a building. Accordingly, the air conditioner unit generally extends through, for example, an outer wall of the structure. Generally, a fan may be operable to rotate to motivate air through the indoor portion. Another fan may be operable to rotate to motivate air through the outdoor portion. A sealed cooling system including a compressor is generally housed within the air conditioner unit to treat (e.g., cool or heat) air as it is circulated through, for example, the indoor portion of the air conditioner unit. One or more control boards are typically provided to direct the operation of various elements of the particular air conditioner unit. In some air conditioner units, the compressor may also be a variable speed compressor capable of operating at a selected speed within a range of operating speeds.

In any of the above-mentioned example appliances, or other appliances that include a sealed system with a compressor, the compressor motor may become demagnetized, and such demagnetization may adversely impact the compressor performance and efficiency. For example, the compressor motor may become demagnetized over time if it becomes too hot, too much current is sent through the windings during field weakening, or a variety of other possible causes.

As a result, further improvements to appliances compressors may be advantageous. In particular, it would be useful to provide systems and methods for detecting demagnetization of such compressors.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a method of operating an appliance is provided. The appliance includes a sealed system. The sealed system includes a compressor operable to drive a refrigerant through the sealed system to perform a thermodynamic cycle. The method includes operating the compressor to drive the refrigerant through the sealed system, which causes the refrigerant to flow to, and change phases at, a heat exchanger of the sealed system. The method also includes estimating a flux of the compressor while operating the compressor and comparing the estimated flux of the compressor to a nominal flux of the compressor. The method further includes setting a fault condition of the compressor in response to comparing the estimated flux of the compressor to the nominal flux of the compressor.

In another exemplary aspect of the present disclosure, a method of operating an appliance is provided. The appliance includes a sealed system. The sealed system includes a compressor operable to drive a refrigerant through the sealed system to perform a thermodynamic cycle. The method includes operating the compressor to drive the refrigerant through the sealed system, which causes the refrigerant to flow to, and change phases at, a heat exchanger of the sealed system. The method also includes estimating a flux of the compressor while operating the compressor and determining the estimated flux of the compressor is below a predefined threshold. The method further includes setting a fault condition of the compressor in response to determining the estimated flux of the compressor is below the predefined threshold.

In another exemplary aspect of the present disclosure, an appliance is provided. The appliance includes a sealed system. The sealed system includes a compressor operable to drive a refrigerant through the sealed system to perform a thermodynamic cycle. The appliance also includes a controller. The controller is configured for operating the compressor to drive the refrigerant through the sealed system, which causes the refrigerant to flow to, and change phases at, a heat exchanger of the sealed system. The controller is also configured for estimating a flux of the compressor while operating the compressor and comparing the estimated flux of the compressor to a nominal flux of the compressor. The controller is further configured for setting a fault condition of the compressor in response to comparing the estimated flux of the compressor to the nominal flux of the compressor.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of an air conditioner unit according to one or more exemplary embodiments of the present disclosure.

FIG. 2 provides a section view of the air conditioner unit of FIG. 1 according to one or more exemplary embodiments of the present disclosure.

FIG. 3 provides a schematic diagram of an example motor of a compressor according to one or more example embodiments of the present disclosure.

FIG. 4A depicts a block diagram of an example implementation of a motor system implementing an observer algorithm according to one or more example embodiments of the present disclosure.

FIG. 4B depicts a block diagram of an example implementation of an observer algorithm (e.g., from the motor system of FIG. 4A) according to one or more example embodiments of the present disclosure.

FIG. 5 provides a flowchart illustrating an example method of operating an appliance according to one or more example embodiments of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “includes” and “including” are intended to be inclusive in a manner similar to the term “comprising.” Similarly, the term “or” is generally intended to be inclusive (i.e., “A or B” is intended to mean “A or B or both”). The terms “upstream” and “downstream” refer to the relative flow direction with respect to fluid flow in a fluid pathway. For example, “upstream” refers to the flow direction from which the fluid flows, and “downstream” refers to the flow direction to which the fluid flows.

As used herein, terms of approximation, such as “generally,” or “about” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

The present subject matter is directed to any appliance which includes a sealed system with a compressor to circulate refrigerant through the sealed system. Such sealed systems may be found in, for example, a refrigerator appliance, a water heater appliance, a laundry dryer appliance, and other appliances.

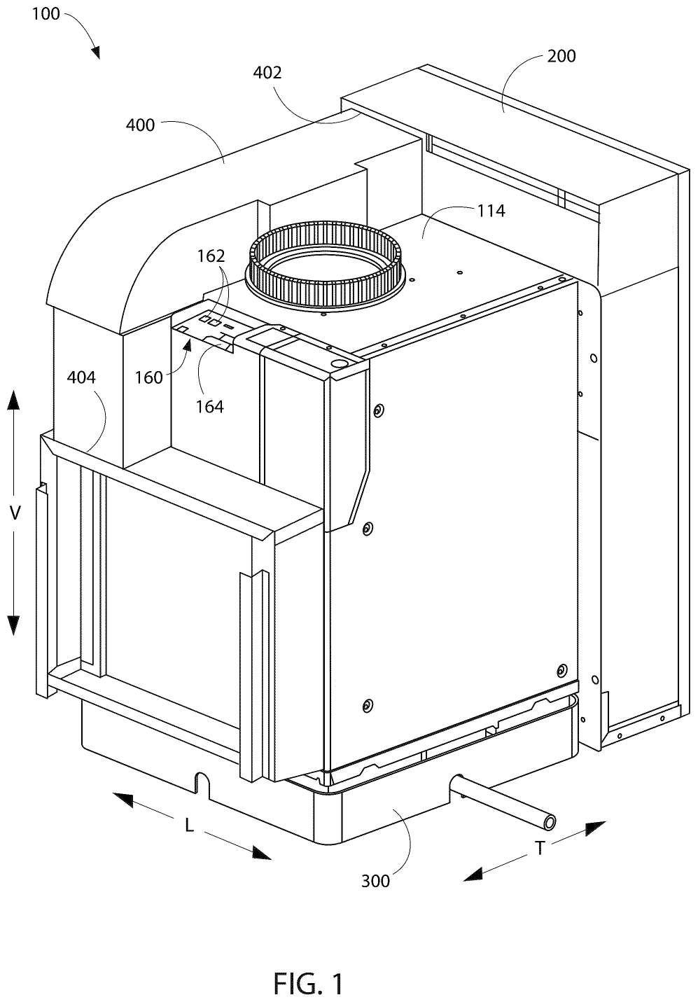

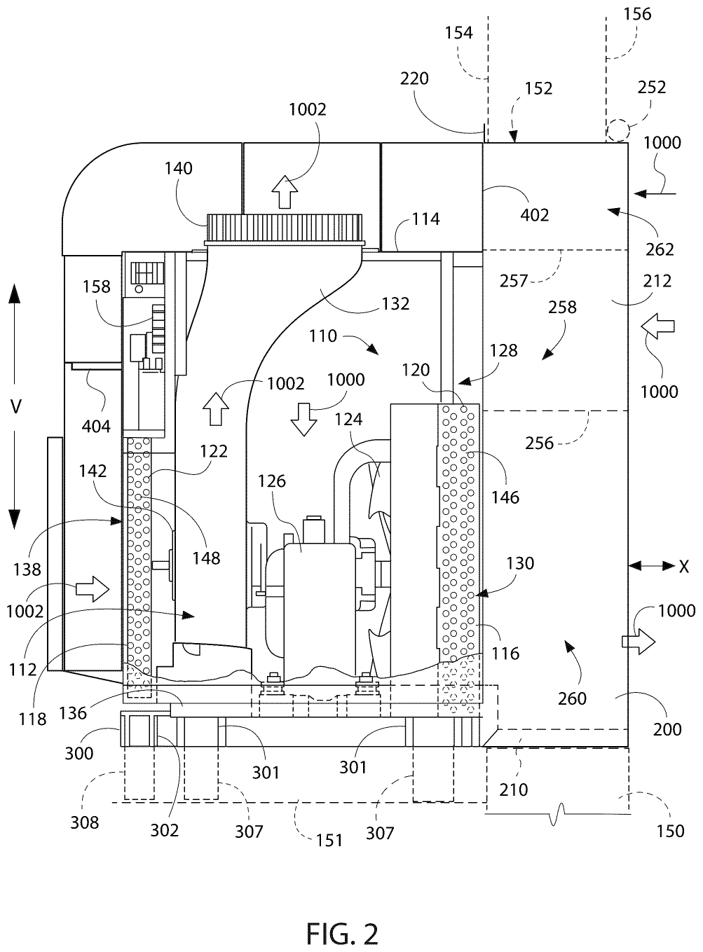

Turning now to the figures, FIGS. 1 and 2 illustrate an exemplary air conditioner appliance or air conditioner unit (e.g., air conditioner 100), which is one embodiment of an appliance which includes a compressor. As shown, air conditioner 100 may be provided as a one-unit type air conditioner 100, such as a single-package vertical unit. Air conditioner 100 includes a package housing 114 supporting an indoor portion 112 and an outdoor portion 110.

Generally, air conditioner 100 defines a vertical direction V, lateral direction L, and transverse direction T. Each direction V, L, T is mutually perpendicular with every other direction, such that an orthogonal coordinate system is generally defined.

In some embodiments, housing 114 contains various other components of the air conditioner 100. Housing 114 may include, for example, a rear opening 116 (e.g., with or without a grill or grate thereacross) and a front opening 118 (e.g., with or without a grill or grate thereacross) may be spaced apart from each other along the transverse direction T. The rear opening 116 may be part of the outdoor portion 110, while the front opening 118 may be part of the indoor portion 112. Components of the outdoor portion 110, such as an outdoor heat exchanger 120, outdoor fan 124, and compressor 126 may be enclosed within housing 114 between front opening 118 and rear opening 116. In certain embodiments, one or more components are mounted on a base 136, as shown. The base 136 may be received on or within a drain pan 300.

During certain operations, air 1000 may be drawn to outdoor portion 110 through rear opening 116. Specifically, an outdoor inlet 128 defined through housing 114 may receive outdoor air 1000 motivated by outdoor fan 124. Within housing 114, the received outdoor air 1000 may be motivated through or across outdoor fan 124. Moreover, at least a portion of the outdoor air 1000 may be motivated through or across outdoor heat exchanger 120 before exiting the rear opening 116 at an outdoor outlet 130. It is noted that although outdoor inlet 128 is illustrated as being defined above outdoor outlet 130, alternative embodiments may reverse this relative orientation (e.g., such that outdoor inlet 128 is defined below outdoor outlet 130) or provide outdoor inlet 128 beside outdoor outlet 130 in a side-by-side orientation, or another suitable orientation.

As shown, indoor portion 112 may include an indoor heat exchanger 122, and an indoor fan 142, e.g., a blower fan 142 as in the illustrated example embodiment. These components may, for example, be housed behind the front opening 118. A bulkhead may generally support or house various other components or portions thereof of the indoor portion 112, such as the blower fan 142. The bulkhead may generally separate and define the indoor portion 112 and outdoor portion 110 within housing 114.

During certain operations, air 1002 may be drawn to indoor portion 112 through front opening 118. Specifically, an indoor inlet 138 defined through housing 114 may receive indoor air 1002 motivated by blower fan 142. At least a portion of the indoor air 1002 may be motivated through or across indoor heat exchanger 122 before passing to a duct 132. The indoor air 1002 may be motivated (e.g., by fan 142) into and through the duct 132 and returned to the indoor area of the room through an indoor outlet 140 defined through housing 114 (e.g., above indoor inlet 138 along the vertical direction V). Optionally, one or more conduits (not pictured) may be mounted on or downstream from indoor outlet 140 to further guide air 1002 from air conditioner 100. It is noted that although indoor outlet 140 is illustrated as generally directing air upward, it is understood that indoor outlet 140 may be defined in alternative embodiments to direct air in any other suitable direction.

Outdoor and indoor heat exchangers 120, 122 may be components of a thermodynamic assembly (i.e., sealed system), which may be operated as a refrigeration assembly (and thus perform a refrigeration cycle) or, in the case of the heat pump unit embodiment, a heat pump (and thus perform a heat pump cycle). Thus, as is understood, exemplary heat pump unit embodiments may be selectively operated to perform a refrigeration cycle at certain instances (e.g., while in a cooling mode) and a heat pump cycle at other instances (e.g., while in a heating mode). By contrast, exemplary A/C exclusive unit embodiments may be unable to perform a heat pump cycle (e.g., while in the heating mode), but still perform a refrigeration cycle (e.g., while in a cooling mode).

The sealed system may, for example, further include compressor 126 (e.g., mounted on base 136) and an expansion device (e.g., expansion valve or capillary tube—not pictured), both of which may be in fluid communication with the heat exchangers 120, 122 to flow refrigerant therethrough, as is generally understood. The outdoor and indoor heat exchangers 120, 122 may each include coils 146, 148, as illustrated, through which a refrigerant may flow for heat exchange purposes, as is generally understood.

A plenum 200 may be provided to direct air to or from housing 114. When installed, plenum 200 may be selectively attached to (e.g., fixed to or mounted against) housing 114 (e.g., via a suitable mechanical fastener, adhesive, gasket, etc.) and extend through a structure wall 150 (e.g., an outer wall of the structure within which air conditioner 100 is installed) and above a floor 151. In particular, plenum 200 extends along an axial direction X (e.g., parallel to the transverse direction T) through a hole or channel 152 in the structure wall 150 that passes from an internal surface 154 to an external surface 156. Optionally, a caulk bead 252 (i.e., adhesive or sealant caulk) may be provided to join the plenum 200 to the external surface 156 of structure wall 150 (e.g., about or outside from wall channel 152).

The plenum 200 includes a duct wall 212 that is formed about the axial direction X (e.g., when mounted through wall channel 152). Duct wall 212 may be formed according to any suitable hollow shape, such as conduit having a rectangular profile (shown), defining an air channel 210 to guide air therethrough. Moreover, duct wall 212 may be formed from any suitable non-permeable material (e.g., steel, aluminum, or a suitable polymer) for directing or guiding air therethrough. In certain embodiments, plenum 200 further includes an outer flange 220 that extends in a radial direction (e.g., perpendicular to the axial direction X) from duct wall 212. Specifically, outer flange 220 may extend radially outward (e.g., away from at least a portion of the axial direction X or the duct wall 212).

In some embodiments, plenum 200 includes a divider wall 256 within air channel 210. When assembled, divider wall 256 defines a separate upper passage 258 and lower passage 260. For instance, divider wall 256 may extend along the lateral direction L from one lateral side of plenum 200 to the other lateral side. Generally, upper passage 258 and lower passage 260 may divide or define two discrete air flow paths for air channel 210. When assembled, upper passage 258 and lower passage 260 may be fluidly isolated by divider wall 256 (e.g., such that air is prevented from passing directly between passages 258 and 260 through divider wall 256, or another portion of plenum 200). Upper passage 258 may be positioned upstream from outdoor inlet 128. Lower passage 260 may be positioned downstream from outdoor outlet 130.

The plenum 200 may further include a second divider wall 257 which separates a make-up air passage 262 from the remainder of the air channel 210, such as from the upper passage 258 and the lower passage 260. For example, the make-up air passage 262 may be positioned directly above the upper passage 258, whereby the second divider separates and partially defines the make-up air passage 262 and the upper passage 258, e.g., as in the exemplary embodiment illustrated in FIG. 2. Similar to the divider wall 256 described above, the second divider wall 257 may extend along the lateral direction L from one lateral side of plenum 200 to the other lateral side. The make-up air passage 262 may thereby define a discrete air flow path within air channel 210 which is separate and distinct from the upper and lower passages 258 and 260. When assembled, the make-up air passage 262 may be fluidly isolated by the second divider wall 257 from one or both of the upper passage 258 and lower passage 260, e.g., such that air is prevented from passing directly between the make-up air passage 262 and the upper and lower passages 258 and 260 through the second divider wall 257, or any other portion of plenum 200). The make-up air passage 262 may be positioned upstream from a make-up air duct 400. In some embodiments, outdoor air 1000 may be drawn into the make-up air duct 400 by a make-up air fan via the make-up air passage 262. The make-up air duct 400 may extend from a first end 402 at the make-up air passage 262 of the plenum 200 to a second end 404 at the indoor portion 112 of the housing 114, e.g., upstream of the indoor inlet 138, whereby outdoor air, e.g., make-up air, may be provided directly to the indoor portion 112 of the air conditioner 100 via the make-up air duct 400. Thus, the make-up air duct 400 may be a component of a make-up air system or make-up air assembly.

The operation of air conditioner 100 including compressor 126 (and thus the sealed system generally), indoor fan 142, outdoor fan 124, and other suitable components may be controlled by a control board or controller 158. Controller 158 may be in communication (via for example a suitable wired or wireless connection) to such components of the air conditioner 100. By way of example, the controller 158 may include a memory and one or more processing devices such as microprocessors, CPUs or the like, such as general or special purpose microprocessors operable to execute programming instructions or micro-control code associated with operation of air conditioner 100. The memory may be a separate component from the processor or may be included onboard within the processor. The memory may represent random access memory such as DRAM, or read only memory such as ROM or FLASH. In one embodiment, the processor executes programming instructions stored in memory. The memory may be a separate component from the processor or may be included onboard within the processor. Alternatively, controller 158 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software. Further, it should be understood that controllers 158 as disclosed herein are capable of and may be operable to perform any methods and associated method steps as disclosed herein.

Air conditioner 100 may additionally include a control panel 160 (FIG. 1) and one or more user inputs 162, which may be included in control panel 160. The user inputs 162 may be in communication with the controller 158. A user of the air conditioner 100 may interact with the user inputs 162 to operate the air conditioner 100, and user commands may be transmitted between the user inputs 162 and controller 158 to facilitate operation of the air conditioner 100 based on such user commands. A display 164 may additionally be provided in the control panel 160, and may be in communication with the controller 158. Display 164 may, for example be a touchscreen or other text-readable display screen, or alternatively may simply be a light that can be activated and deactivated as required to provide an indication of, for example, an event or setting for the air conditioner 100.

Also as may be seen in FIG. 2, in some instances when the plenum 200 is installed within the wall 150 above the floor 151, the remainder of the air conditioner unit 100 may be suspended or cantilevered from the plenum 200. In order to avoid such cantilever, one or more support legs 307 and/or 308 may be provided between the drain pan 300 and the floor 151, whereby at least some of the weight of the remaining components of the air conditioner unit 100 is shifted off of the plenum 200. Where the installation height of the plenum 200 above the floor 151 varies, the required height of the leg(s) 307 and/or 308 will also vary. Thus, the leg(s) 307 and/or 308 may be cut in the field and custom-fitted to the specific installation.

The drain pan 300 may include one or more sockets which are configured to receive the leg(s) 307 and/or 308. For example, as illustrated in FIG. 2, the drain pan 300 may include a first socket 301 and a second socket 302. As illustrated in FIG. 2, the socket(s) 301 and/or 302 may be positioned opposite the plenum 200 along the transverse direction T. For example, the plenum 200 may be positioned at a first transverse end of the drain pan 300 and the socket(s) 301/302 may be positioned opposite the plenum 200 at or near a second transverse end of the drain pan 300. Also as may be seen in FIG. 2, in some embodiments the drain pan 300 may also or instead include one or more of the sockets 301 and/or 302 at the other end of the pan 300, e.g., proximate the plenum 200. In various embodiments, one or both of the sockets 301 and 302 may be provided. In some embodiments, each socket 301 and 302 may be one of a pair of matching shaped sockets which are spaced apart along the lateral direction L and aligned along the transverse direction T.

The material for the leg(s) 307 and/or 308 may be any suitable material which is strong enough to bear the weight of the housing 114 and drain pan 300. For example, materials which are likely to be readily available during installation of the air conditioner unit and which can be suitable for forming the leg(s) 307 and/or 308 include building materials such as lumber, e.g., dimensional lumber such as a nominal two-inch-by-four-inch board, commonly referred to as a two-by-four, or plumbing, e.g., PVC piping having sufficient size (e.g., outer diameter, wall thickness, etc.). Thus, in some embodiments, the socket, e.g., first socket 301, may have a rectangular cross-section and may thereby be configured to receive a leg 307 made of lumber, such as a two-by-four leg, a two-by-six leg, or a four-by-four leg, etc. Additionally, in some embodiments, the socket, e.g., the second socket 302, may be cylindrical and may thereby be configured to receive a round, e.g., cylindrical, leg 308, such as a piece of piping, e.g., a PVC pipe as mentioned above, or, as another example, a steel pipe or other tubular or solid round leg 308.

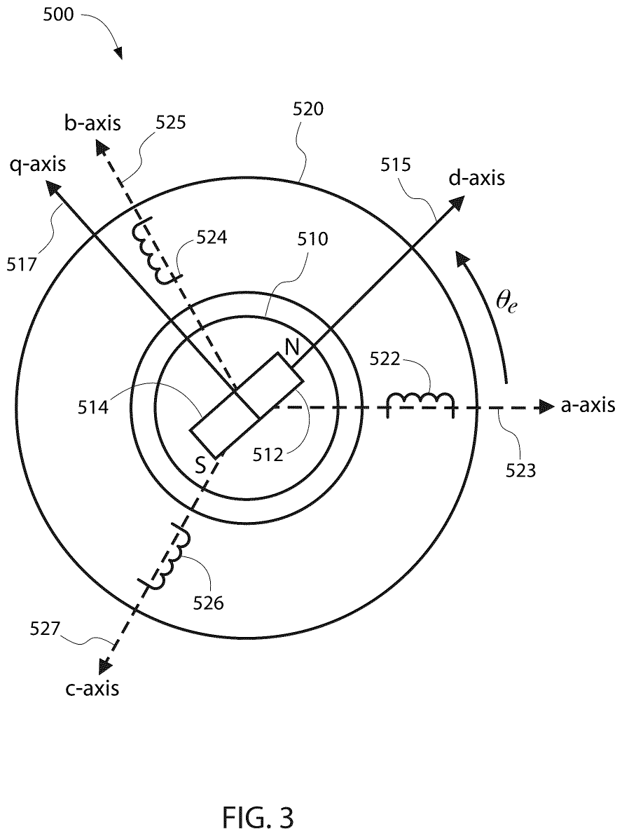

FIG. 3 illustrates one example of a motor for a compressor of an appliance and, as described further below, a flux of the motor may be estimated, such as using an exemplary observer algorithm which will also be described further below.

A motor refers to a class of electro-mechanical device that is capable of producing revolving motion in response to electrical signals. Motors typically include a stationary, and typically mounted, stator configured to encase or surround a rotor. The rotor and/or stator are electrically and/or magnetically charged to induce rotational motion between the rotor or stator. One of ordinary skill in the art will understand that various motors exist in the state of the art, and those variations are within the scope of the present disclosure, when appropriate.

One exemplary class of motor is a synchronous motor. A synchronous motor is a motor that operates using alternating current (AC) and for which, at steady state, rotation is synchronized with a frequency of a supply current. As a result, the rotation period is equal to an integral number of AC cycles. Some synchronous motors include multiphase AC electromagnets on the stator of the motor that create a magnetic field which rotates in time with the oscillations of a line current. The rotor can include magnetic polarization such that the rotor turns in step with the stator field at the same rate and, as a result, provides the second synchronized rotating magnet field of any AC motor. Some synchronous motors, termed “permanent magnet synchronous motors” or PMSMs, include one or more permanent magnets (or other permanently-induced, nonvariant magnetic poles) at the rotor such that the rotor turns with the induced stator field.

For instance, permanent magnet synchronous motors may be driven by field-oriented control (FOC), which provides for efficient and high-fidelity control. In field-oriented control, a stator magnetic field is generated via a stator current provided through one or more stator windings at the stator. The stator field is oriented at a fixed angular offset ahead of a rotor magnetic field at the rotor. For instance, the rotor field may be produced by one or more permanent magnets or other permanent magnetic poles at the rotor. The angular offset between the rotor field and the stator field induces rotational motion at the rotor as the rotor field is made to be aligned with the stator field. By continually moving the stator field (e.g., per phases of the stator current), the rotor is made to synchronously rotate with the stator field.

As mentioned, an observer algorithm may be used to estimate one or more conditions of the motor, such as the flux (e.g., without using sensors to measure such conditions). In some embodiments, the rotor field angle (θₑ) and the angular velocity (ωₑ) of the rotor field may, for example, be the primary variables of interest for the observer, e.g., the variables which are used in the field-oriented control. Additional conditions of the motor, such as flux and/or back electromotive force (EMF), may be intermediate variables that are estimated by the observer. For example, such estimates may be based on input, e.g., voltage and current, supplied to the motor.

Referring specifically to FIG. 3, a schematic diagram of an example permanent magnet synchronous motor 500, which may be a compressor motor, such as a motor of compressor 126 (FIG. 2), according to example embodiments of the present disclosure is provided. As illustrated, motor 500 includes rotor 510 and stator 520. Rotor 510 includes a north magnetic pole 512 and south magnetic pole 514. It should be understood that rotor 510 is discussed with reference to a single north magnetic pole 512 and a single south magnetic pole 514 for the purposes of illustration. Rotor 510 can include any suitable (e.g., balanced) number of north and south magnetic poles. The angle of the rotor magnetic field, represented by θₑ, is related to a mechanical angle of the rotor, represented by θₘ, by a number of rotor poles P. In particular, the angles are related by the equation: θₑ=P/2θₘ. In addition, the (mechanical) rotor speed, represented by

$${ω}_{m} = \frac{d {θ}_{m}}{dt} ,$$

can be related to the electrical rotor speed, represented by

$${ω}_{e} = \frac{d {θ}_{e}}{dt} ,$$

by the equation:

$${ω}_{e} = \frac{P}{2} {ω}_{m} .$$

In operating the motor 500, three-phase power (e.g., current/voltage signals) can be provided at each of the stator windings 522, 524, and 526. For instance, stator winding 522 can be positioned along a-axis 523. Stator winding 524 can be positioned along b-axis 525 and can receive a power signal that is 120 degrees out of phase with the signal of stator winding 522. Additionally, stator winding 526 can be positioned along c-axis 527 and can receive a power signal that is −120 degrees or 240 degrees out of phase with stator winding 522. A convenient way to represent the behavior of the motor 500 is to treat the three-phase voltages and currents as rotating space vectors. The rotating space vectors can be broken up into cartesian components. A first component, termed the direct component or D component, can be in phase with the rotor magnetic field. This component is directed along the d-axis 515. A second component, termed the quadrature component or Q component, can be out of phase with the direct component, such as 90 degrees out of phase with the direct component. For instance, this component can be directed along the q-axis 517.

In particular, voltages and currents in the rotating-space dq reference frame can be translated from the three-phase abc reference frame by suitable transforms. For instance, one example set of transforms, the Park Transform and Clarke Transform, can be performed in cascade to convert between rotating-space and three-phase. In particular, an example Park Transform is given by:

$$[ \begin{matrix}d \\ q\end{matrix} ] = [ \begin{matrix}cos {θ}_{e} & sin {θ}_{e} \\ - sin {θ}_{e} & cos {θ}_{e}\end{matrix} ] [ \begin{matrix}α \\ β\end{matrix} ]$$

and an example Clarke Transform is given by:

$$[ \begin{matrix}α \\ β\end{matrix} ] = [ \begin{matrix}\frac{2}{3} & - \frac{1}{3} & - \frac{1}{3} \\ 0 & \frac{1}{\sqrt{3}} & - \frac{1}{\sqrt{3}}\end{matrix} ] [ \begin{matrix}a \\ b \\ c\end{matrix} ]$$

Note that alternate versions of the above transformations exist, accounting for variations in the location of a zero reference angle, whether the transformation preserves amplitude or power, etc.

In the dq frame, the electrical dynamics of the stator windings can be given by:

$$[ \begin{matrix}{v}_{d} \\ {v}_{q}\end{matrix} ] = [ \begin{matrix}{R}_{s} & - {ω}_{e} {L}_{q} \\ {ω}_{e} {L}_{d} & {R}_{s}\end{matrix} ] [ \begin{matrix}{I}_{d} \\ {I}_{q}\end{matrix} ] + [ \begin{matrix}{L}_{d} & 0 \\ 0 & {L}_{q}\end{matrix} ] [ \begin{matrix}{\dot{I}}_{d} \\ {\dot{I}}_{q}\end{matrix} ] + {λ}_{m} {ω}_{e} [ \begin{matrix}0 \\ 1\end{matrix} ]$$

where Rₛ is the resistance of the stator windings; L_{d}, L_{q} are the d and q axis inductances of the stator windings, which may differ from each other based on the rotor construction; and λₘ is the magnitude of the rotor magnetic flux linkage, which can be constant for a sinusoidal motor. The voltage term λₘ ωₑ is known as the back electromotive force (EMF) (or counter-electromotive force), and, as can be seen in the above equation, has magnitude proportional to the rotor electrical speed ωₑ.

According to example aspects of the present disclosure, an observer can estimate the rotor flux space vector, which is used to align the reference frame. The back EMF space vector is the derivative of the rotor flux space vector. Furthermore, example aspects of the present disclosure can include bounding the magnitude of the estimated rotor flux based on a nominal value. Furthermore, the back EMF vector can be based at least in part on the bounded estimated rotor flux. This can provide for improved robustness to voltage discrepancies. This, in turn, can provide for tracking rotor speed and/or angle to near-zero. For instance, the estimated rotor flux vectors can be multiplied by an estimated speed to obtain the back EMF signals.

In addition, the magnitude of the rotor flux vectors can be constrained such that the amplitude of the estimated back EMF can be tied to the estimated speed. This can prevent the estimated speed from increasing out of control when the real back EMF is small, but has uncertain orientation. This can provide that, even if the estimated rotor angle is not entirely accurate, the estimated rotor angle will not increase (or decrease) out of control either, and will thus experience relatively acceptable deviation at worst, especially in cases where the speed is only near zero temporarily, such as in the case of a motor direction change.

The observer according to example aspects of the present disclosure can be provided in an estimated rotating reference frame based on an estimated rotor angle. In this reference frame, the three-phase system states, such as current, voltage, and flux, can appear as two-phase DC signals, including a component in phase with the rotor flux angle (along what is termed the “direct axis”) and a component which is orthogonal to it (along which is termed the “quadrature axis”). Representing these components as DC components can provide for improved ease of tracking the components.

In some implementations, transforming signals (e.g., current measurements) from a three-phase reference frame to the estimated rotating reference frame comprises implementing a Park transform and a Clarke transform with respect to the estimated rotor angle. For instance, according to example aspects of the present disclosure, an estimated rotor angle \hat{θ} ₑ can be substituted in place of an actual rotor angle θₑ in the aforementioned Park Transform. This estimated rotor angle can be used in the absence of a known rotor angle. To differentiate from the earlier dq reference frame, the axes defined by this transformation are denoted as γδ, where the γ-axis is analogous to the d-axis and the δ-axis is analogous to the q-axis. This transformation yields the following current dynamic model in an estimated rotating reference frame, the γδ frame:

$$[ \begin{matrix}{v}_{γ} \\ {v}_{δ}\end{matrix} ] = [ \begin{matrix}R & - {\dot{\hat{θ}}}_{e} L \\ {\dot{\hat{θ}}}_{e} L & R\end{matrix} ] [ \begin{matrix}{I}_{γ} \\ {I}_{δ}\end{matrix} ] + L [ \begin{matrix}{\dot{I}}_{γ} \\ {\dot{I}}_{δ}\end{matrix} ] + {ω}_{e} [ \begin{matrix}- {λ}_{{r}_{δ}} \\ {λ}_{{r}_{γ}}\end{matrix} ]$$

where [symbol] ₑ is the derivative of \hat{θ} ₑ and where the γδ flux terms have the following form:

$$[ \begin{matrix}{λ}_{{r}_{γ}} \\ {λ}_{{r}_{δ}}\end{matrix} ] = {λ}_{m} [ \begin{matrix}cos {\tilde{θ}}_{e} \\ sin {\tilde{θ}}_{e}\end{matrix} ]$$

where \tilde{θ}ₑ=θₑ−\hat{θ} ₑ is the angle error. As can be seen in the above equations, when \tilde{θ}ₑ=θₑ, meaning that the estimated rotor angle is equivalent to the actual rotor angle, the model becomes equivalent to the earlier dq model, which means λᵣ_{_{γ}}=λₘ and λᵣ_{_{δ}}=0.

Thus, according to example aspects of the present disclosure, the γδ reference frame can be useful in designing an observer that is configured to determine rotor speed and angle of a motor without requiring the use of speed or angle sensors. In particular, measured voltage and current can be used along with an estimated speed and rotor flux to estimate the rotating current vector. The estimated current vector can be compared with the measured current vector to produce a current error. This current error can then be used to update the estimated rotor flux. The estimated rotor flux can, in turn, be used to track rotor angle and/or rotor speed. For instance, the rotor flux vector can be designed to ideally have a zero magnitude at the q-axis, and, as such, the quadrature component of the rotor flux can be used as feedback to update the estimated speed and/or angle.

For instance, according to example aspects of the present disclosure, a controller can determine an initial estimated rotor angle. The initial estimated rotor angle can be determined in any suitable manner. For instance, as one example, the estimated rotor angle can be zero degrees and can be assigned upon initial energization of the motor.

The controller can additionally determine one or more estimated currents defined by an estimated rotating reference frame based at least in part on the estimated rotor angle. For instance, the γδ currents Î_{γ}, Î_{δ} can be determined in the estimated rotating reference frame, the γδ frame, based on the estimated rotor angle \hat{θ} ₑ.

Additionally, the controller can obtain one or more current measurements of one or more measured currents respective to the one or more estimated currents. For instance, the actual currents can be measured from the motor and/or transformed to an appropriate reference frame. As one example, the measured currents may be measured by one or more current probes at the motor, such as at the stator windings and/or transformed by Park Transform and/or Clarke Transform.

Additionally, the controller can be configured to determine one or more current errors. For instance, the current errors can be determined by a subtractive combination of the one or more estimated currents and the one or more measured currents. As one example, the error signals can be determined by subtracting the one or more measured currents from the one or more actual currents. For instance, this is mathematically illustrated in the below equation, where Ĩ_{γ} and Ĩ_{δ} are the current errors:

$${\tilde{I}}_{γ} = {\hat{I}}_{γ} - {I}_{γ}$$

$${\tilde{I}}_{δ} = {\hat{I}}_{δ} - {I}_{δ}$$

The current estimates can be included in a closed-loop feedback system based at least in part on the one or more measured currents and the one or more current errors and based at least in part on a functional relationship between the one or more updated current estimates, the one or more measured currents, and one or more rotor flux estimates. For instance, in one example implementation according to example aspects of the present disclosure, the design of the estimated current is based on the following functional relationship(s):

$${\hat{I}}_{γ} = \int \frac{1}{{L}_{d}} [ {v}_{γ} - {R}_{s} {I}_{γ} + {\dot{\hat{θ}}}_{e} ( {L}_{q} {I}_{δ} + {\hat{λ}}_{{r}_{δ}} ) - {k}_{1} {\tilde{I}}_{γ} ]$$

$${\hat{I}}_{δ} = \int \frac{1}{{L}_{q}} [ {v}_{δ} - {R}_{s} {I}_{δ} - {\dot{\hat{θ}}}_{e} ( {L}_{d} {I}_{γ} + {\hat{λ}}_{{r}_{γ}} ) - {k}_{1} {\tilde{I}}_{δ} ]$$

where k₁ is a feedback gain, and \hat{λ}ᵣ_{_{γ}}, \hat{λ}ᵣ_{_{δ}} are rotor flux estimates. According to example aspects of the present disclosure, rotor flux estimates can be a useful component of observers, and in particular at low speeds.

For instance, according to example aspects of the present disclosure, the controller can determine one or more rotor flux estimates based at least in part on the one or more current errors. For instance, the rotor flux estimates can be space vectors in the γδ reference frame, such as vectors including a γ-directed rotor flux vector, \hat{λ}ᵣ_{_{γ}}, and a δ-directed rotor flux vector, \hat{λ}ᵣ_{_{δ}}. In some implementations, the rotor flux estimates can be modeled according to an integral over an additive combination of a first feedback-weighted current error of the current error(s) and the multiplicative combination of the estimated rotor angle and a second current error of the current error(s). The first current error and the second current error can be positioned with respect to differing axes of the γδ reference frame. For instance, in one example implementation, the rotor flux estimates can be defined as:

$${\hat{λ}}_{{r}_{γ}} = \int [ {k}_{1} {\tilde{I}}_{γ} + {\dot{\hat{θ}}}_{e} {\tilde{I}}_{δ} ]$$

$${\hat{λ}}_{{r}_{δ}} = \int [ {k}_{1} {\tilde{I}}_{δ} - {\dot{\hat{θ}}}_{e} {\tilde{I}}_{γ} ]$$

Note that when the estimated rotor angle is equivalent to an actual rotor angle (e.g., \hat{θ}ₑ=θₑ) then the magnitude of the y-directed rotor flux vector is equivalent to the magnitude of the rotor magnetic flux linkage (e.g., λᵣ_{_{γ}}=λₘ). Because of this, it is possible to set bounds on the integration of \hat{λ}ᵣ_{_{γ}} to keep it near λₘ. Furthermore, when the estimated rotor angle and actual rotor angle are equivalent, the magnitude of the δ-directed rotor flux estimate should be zero. Because of this, it is possible to use the estimated δ-directed rotor flux vector, \hat{λ}ᵣ_{_{δ}} as a feedback term to update the estimated speed and angle.

For instance, the controller can additionally be configured to determine an estimated rotor speed, represented by \hat{ω}ₑ. For instance, in some implementations, the estimated rotor speed can be determined based at least in part on an integral of the estimated δ-directed rotor flux vector. The integral term can be weighted by a feedback gain. One example implementation of the integral is given by the equation below, where k_{ω} is a feedback gain:

$${\hat{ω}}_{e} = \int {k}_{ω} {\hat{λ}}_{{r}_{δ}}$$

In addition, the controller can be configured to determine an updated estimated rotor angle of the rotor based at least in part on the estimated rotor speed. Additionally and/or alternatively, the updated estimated rotor angle of the rotor can be determined based at least in part on the one or more rotor flux estimates, such as the estimated δ-directed rotor flux vector. As one example, the updated estimated rotor angle of the rotor can be determined based at least in part on an integral of the sum of the estimated rotor speed and the estimated δ-directed rotor flux vector. The sum may be weighted based on one or more feedback gains. One example implementation of this integral is given below, where k_{θ} is a feedback gain, and wherein the term being integrated is the derivative of the estimated angle, [symbol] ₑ:

$${\hat{θ}}_{e} = \int [ {\hat{ω}}_{e} + {k}_{θ} {\hat{λ}}_{{r}_{δ}} ]$$

The examples described above, and in particular the example rotor fluxes described above, are discussed with reference to the γδ reference frame as individual components projected onto each axis, (e.g., λᵣ_{_{γ}}, λᵣ_{_{δ}}). This is referred to as a Cartesian representation. As an alternative, the rotor flux vector can be represented in Polar form, such as by splitting the rotor flux vector into a magnitude component and a phase component. For instance, the magnitude component can be the magnitude of the rotor magnetic flux linkage, represented by λₘ. Additionally and/or alternatively, the phase component can be represented by the angle error \tilde{θ}ₑ. These representations can have a relationship with the Cartesian components that is given by standard Polar transforms. For instance, as given below:

$$[ \begin{matrix}{λ}_{{r}_{γ}} \\ {λ}_{{r}_{δ}}\end{matrix} ] = {λ}_{m} [ \begin{matrix}cos {\tilde{θ}}_{e} \\ sin {\tilde{θ}}_{e}\end{matrix} ]$$

Thus, the observer may instead be designed to estimate the rotor magnetic flux linkage and angle error in place of the estimated rotor fluxes in the Cartesian representation. As an example, in some implementations, the magnitude of the estimated rotor flux may be based at least in part on the one or more current errors in the γδ reference frame and the estimated rotor angle. For instance, one example implementation of Polar estimated rotor flux vectors is given by the below equations:

$${\hat{λ}}_{m} = \int [ cos {\hat{\tilde{θ}}}_{e} ( {k}_{I} {\tilde{I}}_{γ} + {k}_{λ} {\dot{\hat{θ}}}_{e} {\tilde{I}}_{δ} ) + sin {\hat{\tilde{θ}}}_{e} ( {k}_{I} {\tilde{I}}_{δ} - {k}_{λ} {\dot{\hat{θ}}}_{e} {\tilde{I}}_{γ} ) ]$$

$${\hat{\tilde{θ}}}_{e} = \int [ \frac{1}{{\hat{λ}}_{m}} ( cos {\hat{\tilde{θ}}}_{e} ( {k}_{I} {\tilde{I}}_{δ} - {k}_{λ} {\dot{\hat{θ}}}_{e} {\tilde{I}}_{γ} ) - sin {\hat{\tilde{θ}}}_{e} ( {k}_{I} {\tilde{I}}_{γ} + {k}_{λ} {\dot{\hat{θ}}}_{e} {\tilde{I}}_{δ} ) ) ]$$

where \hat{λ}ₘ is an estimated rotor flux magnitude component and [symbol] is an estimated rotor flux phase component and/or an estimated rotor angle error.

Additionally, the controller can estimate the rotor speed and rotor angle based on the Polar estimated rotor flux vectors. As one example, the estimated rotor speed can be based at least in part on an integral of the estimated rotor angle error. Additionally and/or alternatively, the rotor angle can be based at least in part on an integral of an additive combination of the estimated rotor speed and the estimated rotor angle error. One example implementation of these integrals is given below:

$${\hat{ω}}_{e} = \int {k}_{ω} {\hat{\tilde{θ}}}_{e}$$

$${\hat{θ}}_{e} = \int [ {\hat{ω}}_{e} + {k}_{θ} {\hat{\tilde{θ}}}_{e} ]$$

In some implementations, designing the observer in Polar form can be useful in separately tuning a convergence rate of the magnitude component (e.g., the rotor magnetic flux linkage) and the phase component (e.g., the angle error). For instance, in some implementations, it may be desirable to have a lower convergence rate of the magnitude component than the phase component such that the phase component converges faster than the magnitude component (e.g., if the magnitude component is ideally a constant value).

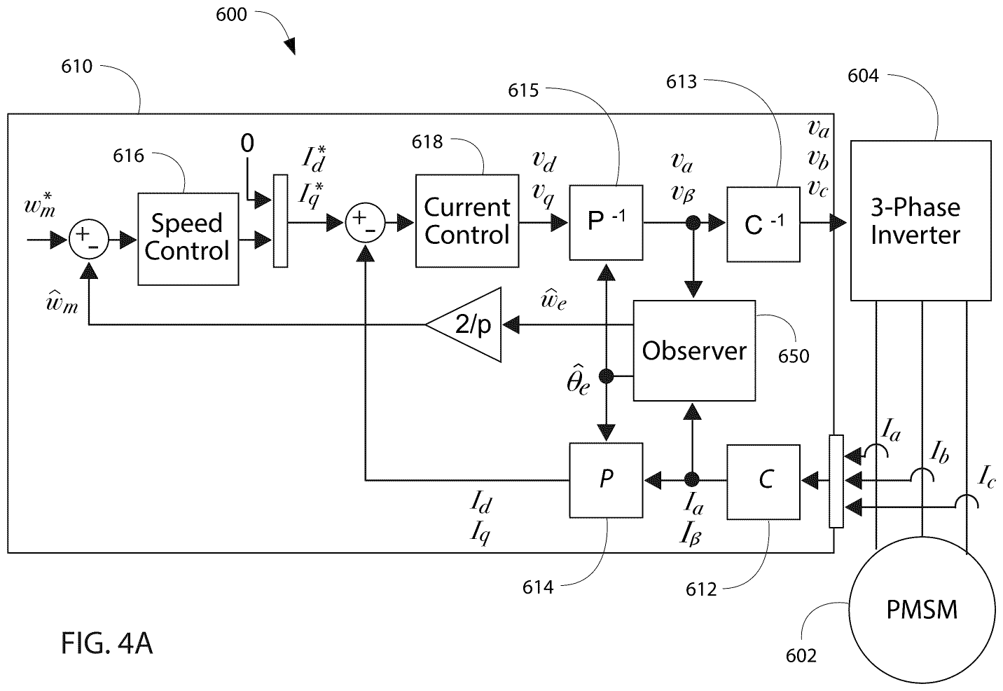

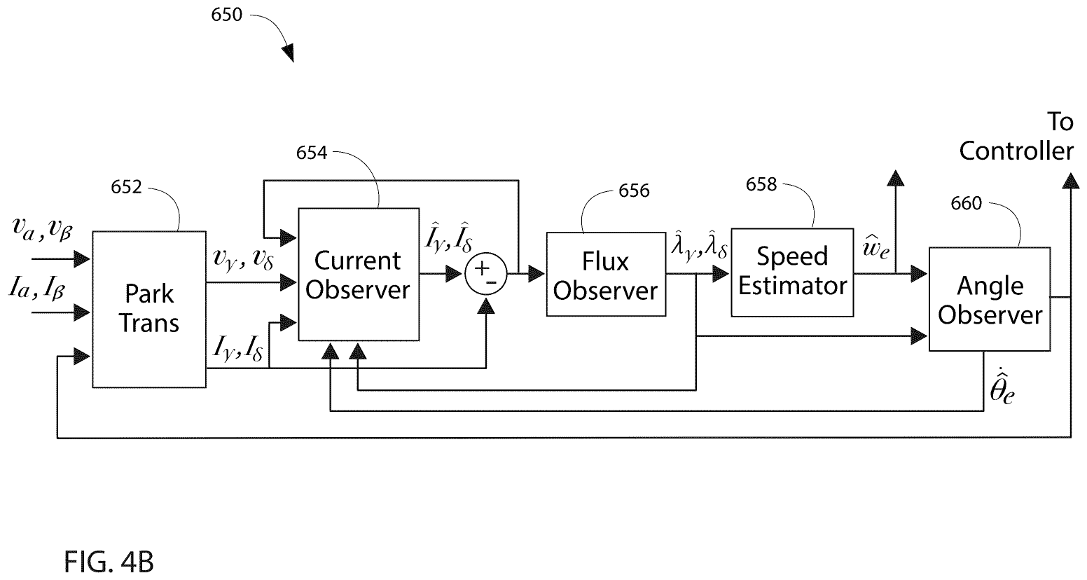

For instance, FIG. 4A depicts a block diagram of an example implementation of a motor control system 600 implementing an observer algorithm according to example embodiments of the present disclosure. The motor system 600 can include motor 602, such as a permanent magnet synchronous motor. The three-phase inverter 604 can be configured to control motor 602. For instance, inverter 604 can supply current signals to windings at motor 602 such that the motor 602 produces rotational motion. As one example, the inverter 604 can supply three-phase current signals Iₐ, I_{b}, and I_{c} to stator windings at the motor 602 in synchronous timing such that a (e.g., permanent magnet) rotor at motor 602 rotates. The inverter can produce the current signals in response to a control signal from a controller (e.g., current controller 618).

As mentioned, the motor control system 600 of FIG. 4A can implement an observer algorithm. One example of such an observer algorithm is observer algorithm 650 discussed with reference to FIG. 4B. The observer algorithm may be implemented in a different reference frame than the three phase reference frame of motor 602 and/or inverter 604. For instance, the current signals from the inverter 604 can be transformed by Clarke transform 612 and/or Park transform 614 into a rotating reference frame (e.g., an estimated rotating reference frame). For instance, the current signals can be transformed into an alpha-beta reference frame by the Clarke transform 612, and the signals from Clarke transform 612 can be used by the observer 650 to produce an estimated angle. The estimated angle can be used in Park transform 614 to produce signals in an estimated rotating reference frame.

The observer 650 can additionally produce an estimated speed. The estimated speed can be compared to a target speed to determine a speed error. The speed error can be provided to speed control 616 to determine target current signals. The target current signals can be produced in the rotating reference frame. The target current signals can be compared to the measured current signals (e.g., from Park transform 614) to determine current error signals. The current error signals can be used by current controller 618 to produce control signals for inverter 604. For instance, the control signals can be voltage signals. The voltage signals may be in the rotating reference frame. The voltage signals can be transformed (e.g., by inverse Park transform 615 and inverse Clarke transform 613) to the three-phase reference frame to be used by inverter 604.

FIG. 4B depicts a block diagram of an example implementation of an observer algorithm 650 (e.g., from the motor system 600 of FIG. 4A) according to example embodiments of the present disclosure. For instance, the observer algorithm 650 can receive voltage signals and/or current signals in the alpha-beta reference frame. The observer algorithm 650 can include Park transform 652 that can transform the signals in the alpha-beta reference frame to the estimated rotating reference frame based at least in part on the estimated angle from the observer algorithm 650. The current observer 654 can produce estimated currents in the estimated rotating reference frame. For instance, the current observer 654 can produce the estimated currents based at least in part on the measured currents in the estimated rotating reference frame, rotor flux estimates, and/or a derivative of the estimated angle. For instance, each of these values can be provided as feedback to the current observer 654

The estimated currents produced by the current observer 654 can be subtractively combined with the actual currents from the Park transform 652 to produce current errors. The current errors can be provided to flux observer 656. The flux observer 656 can produce rotor flux estimates based at least in part on the current errors, as described herein. The rotor flux estimates can be used as feedback at current observer 654. Additionally, the rotor flux estimates can be provided to speed estimator 658. The speed estimator 658 can produce an estimated speed of the rotor based at least in part on the rotor flux estimates. The rotor flux estimates and/or the estimated rotor speed can be provided to angle observer 660. The angle observer 660 can determine an updated estimated rotor angle of the rotor based at least in part on the estimated rotor speed and/or the rotor flux estimates.

Referring again to FIG. 4A, it should be understood that some or all of these components may be implemented by a controller, e.g., a dedicated controller 610 as indicated in FIG. 4A, or by controller 158 (which may be separate from or integrated with controller 610), or the implementation may be distributed among multiple controllers. For instance, in some embodiments, the controller 610 may be a computing device (e.g., including one or more processors) that is configured to implement the observer algorithm 650 and/or various other operations described in FIGS. 4A and 4B (e.g., Clarke transform 612, inverse Clarke transform 613, Park transform 614, inverse Park transform 615, observer 650, etc.). Additionally and/or alternatively, any of the operations (e.g., observer 650) may be implemented by discrete circuitry (e.g., analog circuitry) such as a programmable logic gate array, integrated circuit(s), or other suitable circuitry.

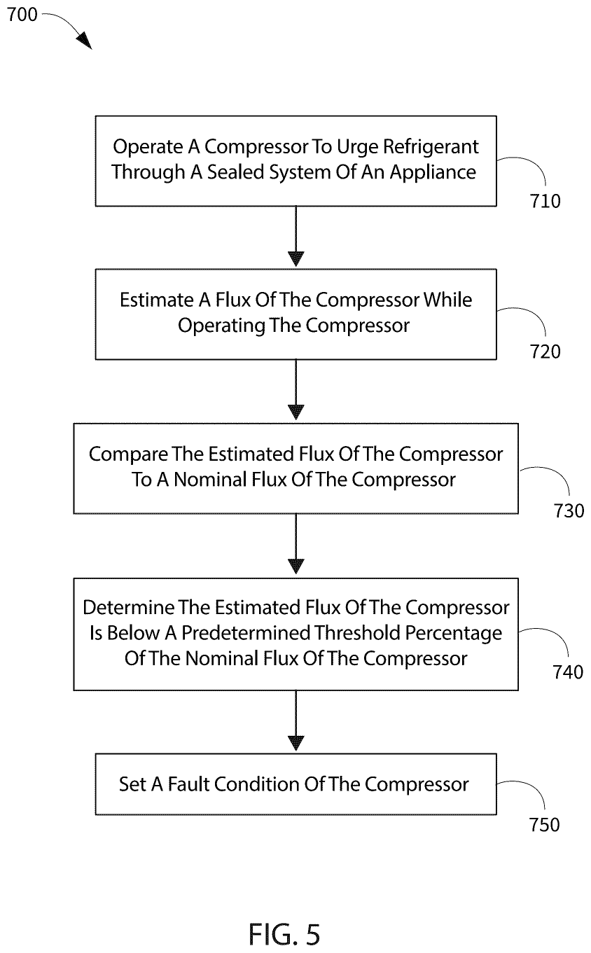

Turning now to FIG. 5, embodiments of the present disclosure also include methods of operating an appliance such as method 700 illustrated in FIG. 5, where the appliance may be, e.g., the air conditioner unit 100 illustrated in FIGS. 1 and 2 and described above, among other possible example appliances which include a sealed system having a compressor. Thus, exemplary appliances which may be operated according to method 700 may include a sealed system. The sealed system may include a compressor operable to move, e.g., motivate, urge, circulate and/or drive, a refrigerant through the sealed system to perform a thermodynamic cycle, e.g., a thermodynamic heat pump cycle or a thermodynamic refrigeration cycle, such as a vapor-compression cycle, or other similar cycle as is understood by those of ordinary skill in the art.

As illustrated in FIG. 5, the method 700 may include (710) operating the compressor to drive the refrigerant through the sealed system. Operating the compressor causes the refrigerant to flow to and change phases at a heat exchanger of the sealed system, e.g., the compressor may drive a vapor-phase refrigerant to a condenser of the sealed system, where the refrigerant releases heat, such that the refrigerant condenses from vapor to liquid. The heat released from the refrigerant at the condenser may be used, e.g., to heat water in a tank of a water heater appliance, to heat a flow of air in a laundry dryer appliance, or, in an HVAC appliance, to reject heat from indoors to outdoors (e.g., in a cooling mode) or to provide flow of heated air to a conditioned space (e.g., in a heating mode or heat pump mode), among other possible examples in various appliances which include a sealed system having a compressor.

Also as may be seen in FIG. 5, method 700 may further include (720) estimating a flux of the compressor while operating the compressor. For example, the flux of the compressor may be estimated by an observer algorithm, such as the exemplary observer algorithm described above, e.g., the flux observer 656 thereof.

The estimated flux may be used to detect (e.g., in real-time or instantaneously) or predict and prevent impaired operation of the compressor, such as demagnetization of a motor of the compressor. For example, methods according to the present disclosure such as method 700 may include (730) comparing the estimated flux of the compressor to a nominal flux of the compressor and/or (740) determining the estimated flux of the compressor is below a predefined threshold. For example, the predetermined threshold may be a percentage of the nominal flux of the compressor, such as about 80% or less, such as about 75% or less.

In response to (730) and/or (740), method 700 may include setting a fault condition of the compressor. Thus, in various embodiments, method 700 may include (750) setting a fault condition of the compressor, e.g., in response to comparing the estimated flux of the compressor to the nominal flux of the compressor and/or determining the estimated flux of the compressor is below the predefined threshold. The fault condition may be an immediate or present fault condition, or may be a potential fault condition. Setting the potential fault condition may include storing the potential fault condition or an indicator thereof in a memory, such as a memory of a controller of the appliance, and the potential fault may be subject to further analysis, as will be described below. When the fault condition is a present fault condition, one or more remedial actions may be implemented in response to the present fault condition. For example, a remedial action may be or may include providing an alert, such as a user notification presented on a user interface of the appliance via the controller and/or on a remote user interface. Implementing a remedial action may also or instead include deactivating the compressor and preventing further operation (e.g., reactivation) of the compressor.

In embodiments where the fault condition is a potential fault condition, methods according to the present subject matter may further include, e.g., after setting the potential fault condition, estimating the flux of the compressor over multiple operation cycles of the compressor and determining a present fault when the flux of the compressor is below the predefined threshold after a specified number of operating cycles, e.g., “N” operating cycles, such as two, or three, or five, or more operating cycles. For example, such embodiments may include estimating a second flux of the compressor during a subsequent operation of the compressor and determining the estimated second flux of the compressor during the subsequent operation of the compressor is below the predefined threshold percentage of the nominal flux of the compressor. Thus, a remedial action may be implemented in response to the estimated flux below the predefined threshold over the multiple, e.g., two or more, cycles. For example, the remedial action may be implemented in response to the potential fault condition and the second flux of the compressor during the subsequent operation of the compressor below the predefined threshold percentage of the nominal flux of the compressor.

In some embodiments, multiple predefined thresholds may be used, and progressive remedial actions may be taken when the estimated flux (either in a single cycle or over multiple cycles) falls below each successively lower predefined threshold. For example, when the estimated flux is below a first (highest) predefined threshold but above other predefined thresholds, a potential fault condition may be set. Then, when the estimated flux is below a second (lower than the first but higher than others) predefined threshold, an alert may be provided, and when the estimated flux later falls below a third (lower than the first and second) predefined threshold, the compressor may be shut down and locked out. Thus, for example, the predefined threshold at (740) may be a first predefined threshold, and methods such as method 700 may further include comparing the estimated flux to a second predefined threshold (the second predefined threshold less than the first predefined threshold) and implementing a remedial action in response to the estimated flux less than the second predefined threshold (e.g., in addition to setting the potential fault in response to the estimated flux below the first threshold, it being understood that, where the second predefined threshold is less than the first predefined threshold, the estimated flux below the second predefined threshold is also necessarily below the first predefined threshold).

As mentioned above, some embodiments may include predicting the flux of the compressor, such as predicting when the flux of the compressor will fall below one or more predefined thresholds. For example, methods such as method 700 may include tracking the estimated flux of the compressor over time (e.g., every cycle, every day, every week, or every month, etc.) during multiple operations of compressor. Such embodiments may further include using the historical data (from every cycle or every day, etc., as noted) to project the future flux of the compressor by various means (e.g., linear regression, etc.). In such embodiments, if the flux is projected to drop below a predefined threshold of the nominal value at a future date, such as within a time limit (e.g., 14 days in the future, or less than 14 days such as 10 days, or 7 days, or less, or more than 14 days, such as 18 days, 21 days, or more), a fault may be set, e.g., a potential fault or a present fault, and/or one or more remedial actions may be implemented. For example, methods such as method 700 may include predicting a future flux of the compressor based on the tracked estimated flux of the compressor and comparing the predicted future flux of the compressor to the nominal flux of the compressor. In such embodiments, the fault condition, e.g., at (750) may be set in response to comparing the estimated flux of the compressor to the nominal flux of the compressor and in response to comparing the predicted future flux of the compressor to the nominal flux of the compressor, such as predicting the future flux of the compressor will be below a predefined threshold percentage of the nominal flux of the compressor within a time limit.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of operating an appliance, the appliance comprising a sealed system, the sealed system comprising a compressor operable to drive a refrigerant through the sealed system to perform a thermodynamic cycle, the method comprising:
operating the compressor to drive the refrigerant through the sealed system, whereby the refrigerant flows to and changes phases at a heat exchanger of the sealed system;
estimating a flux of the compressor while operating the compressor;
comparing the estimated flux of the compressor to a nominal flux of the compressor; and
setting a fault condition of the compressor in response to comparing the estimated flux of the compressor to the nominal flux of the compressor.

2. The method of claim 1, wherein comparing the estimated flux of the compressor to the nominal flux of the compressor comprises determining the estimated flux of the compressor is below a predefined threshold percentage of the nominal flux of the compressor.

3. The method of claim 2, wherein the fault condition is a potential fault condition, further comprising estimating a second flux of the compressor during a subsequent operation of the compressor, determining the estimated second flux of the compressor during the subsequent operation of the compressor is below the predefined threshold percentage of the nominal flux of the compressor, and implementing a remedial action in response to the potential fault condition and the second flux of the compressor during the subsequent operation of the compressor below the predefined threshold percentage of the nominal flux of the compressor.

4. The method of claim 2, wherein the predefined threshold is a first predefined threshold, further comprising comparing the estimated flux to a second predefined threshold, the second predefined threshold less than the first predefined threshold, further comprising implementing a remedial action in response to the estimated flux less than the second predefined threshold.

5. The method of claim 1, further comprising tracking the estimated flux of the compressor over time during multiple operations of compressor, predicting a future flux of the compressor based on the tracked estimated flux of the compressor, and comparing the predicted future flux of the compressor to the nominal flux of the compressor, wherein the fault condition is set in response to comparing the estimated flux of the compressor to the nominal flux of the compressor and in response to comparing the predicted future flux of the compressor to the nominal flux of the compressor.

6. The method of claim 5, wherein comparing the predicted future flux of the compressor to the nominal flux of the compressor comprises predicting the future flux of the compressor below a predefined threshold percentage of the nominal flux of the compressor within a time limit.

7. A method of operating an appliance, the appliance comprising a sealed system, the sealed system comprising a compressor operable to drive a refrigerant through the sealed system to perform a thermodynamic cycle, the method comprising:
operating the compressor to drive the refrigerant through the sealed system, whereby the refrigerant flows to and changes phases at a heat exchanger of the sealed system;
estimating a flux of the compressor while operating the compressor;
determining the estimated flux of the compressor is below a predefined threshold; and
setting a fault condition of the compressor in response to determining the estimated flux of the compressor is below the predefined threshold.

8. The method of claim 7, wherein the predefined threshold comprises a percentage of a nominal flux of the compressor.

9. The method of claim 7, wherein the predefined threshold is a first predefined threshold, further comprising comparing the estimated flux to a second predefined threshold, the second predefined threshold less than the first predefined threshold, further comprising implementing a remedial action in response to the estimated flux less than the second predefined threshold.

10. The method of claim 7, further comprising tracking the estimated flux of the compressor over time during multiple operations of compressor, predicting a future flux of the compressor based on the tracked estimated flux of the compressor, and determining the predicted future flux of the compressor is below the predefined threshold, wherein the fault condition is set in response to determining the estimated flux of the compressor is below a predefined threshold and in response to determining the predicted future flux of the compressor is below a predefined threshold.

11. The method of claim 7, wherein the fault condition is a potential fault condition, further comprising estimating a second flux of the compressor during a subsequent operation of the compressor, determining the estimated second flux of the compressor during the subsequent operation of the compressor is below the predefined threshold, and implementing a remedial action in response to the potential fault condition and the second flux of the compressor during the subsequent operation of the compressor below the predefined threshold.

12. An appliance, comprising:
a sealed system, the sealed system comprising a compressor operable to drive a refrigerant through the sealed system to perform a thermodynamic cycle; and
a controller, the controller configured for:
operating the compressor to drive the refrigerant through the sealed system, whereby the refrigerant flows to and changes phases at a heat exchanger of the sealed system;
estimating a flux of the compressor while operating the compressor;
comparing the estimated flux of the compressor to a nominal flux of the compressor; and
setting a fault condition of the compressor in response to comparing the estimated flux of the compressor to the nominal flux of the compressor.

13. The appliance of claim 12, wherein comparing the estimated flux of the compressor to the nominal flux of the compressor comprises determining the estimated flux of the compressor is below a predefined threshold percentage of the nominal flux of the compressor.

14. The appliance of claim 13, wherein the fault condition is a potential fault condition, wherein the controller is further configured for estimating a second flux of the compressor during a subsequent operation of the compressor, determining the estimated second flux of the compressor during the subsequent operation of the compressor is below the predefined threshold percentage of the nominal flux of the compressor, and implementing a remedial action in response to the potential fault condition and the second flux of the compressor during the subsequent operation of the compressor below the predefined threshold percentage of the nominal flux of the compressor.

15. The appliance of claim 13, wherein the predefined threshold is a first predefined threshold, further comprising comparing the estimated flux to a second predefined threshold, the second predefined threshold less than the first predefined threshold, further comprising implementing a remedial action in response to the estimated flux less than the second predefined threshold.

16. The appliance of claim 12, wherein the controller is further configured for tracking the estimated flux of the compressor over time during multiple operations of compressor, predicting a future flux of the compressor based on the tracked estimated flux of the compressor, and comparing the predicted future flux of the compressor to the nominal flux of the compressor, wherein the fault condition is set in response to comparing the estimated flux of the compressor to the nominal flux of the compressor and in response to comparing the predicted future flux of the compressor to the nominal flux of the compressor.

17. The appliance of claim 16, wherein comparing the predicted future flux of the compressor to the nominal flux of the compressor comprises predicting the future flux of the compressor below a predefined threshold percentage of the nominal flux of the compressor within a time limit.
